(19) United States
(12) Patent Application Publication
(10) Pub. No.: US 2025/0070501 A1
(43) Pub. Date: Feb. 27, 2025

(54) Separable power strip

(71) Applicant: Deals Realm LLC, Eastvale, CA (US)

(72) Inventor: YUEBO TAO, Shenzhen (CN)

(21) Appl. No.: 18/812,200

(22) Filed: Aug. 22, 2024

(30) Foreign Application Priority Data
Aug. 22, 2023 (CN) 202322272996.9

(51) Int. Cl. H01R 13/514; H01R 25/00

(52) U.S. Cl. CPC H01R 13/514; H01R 25/003

(57) ABSTRACT

The present disclosure provides a separable power strip, and the separable power strip includes a main body connected to a power via a power line and including: a first housing including a first contacting wall and a first peripheral side wall surrounding the first contacting wall, the first contacting wall and the first peripheral side wall defining a first receiving cavity; a first socket interface located in the first contacting wall; and a first electrical outlet assembly connected to the first socket interface and the power line, and received in the receiving cavity; and a separable member separably and electrically coupled to the main body and including: a second housing including a second contacting wall; a second socket interface having a different interface type with the first socket interface; and a conducting pin electrically coupled to the second socket interface and located in the second contacting wall

### RELATED APPLICATIONS

This application claims the benefit of priority to Chinese Patent Application Number 202322272996.9 filed on Aug. 22, 2023, in the China National Intellectual Property Administration. The entire contents of the above-identified application are hereby incorporated by reference.

### TECHNICAL FIELD

The disclosure relates to the field of power strip, and in particular to, a separable power strip.

### BACKGROUND

Conventional charging power strips (expansion sockets) are generally only provided with two or three sockets (also referred to as “international universal sockets”). In order to meet the different requirements of consumers and avoid the dilemma of being unable to charge electronic products when users forget to carry charging plugs and data cables, the charging power strips sold on the market, in addition to sockets, are also equipped with interfaces adapted to the USB sockets of commonly used mobile phone data cables. However, the size of this type of charging power strip is constant, it is not possible to change the size of the charging power strip according to the size of the plug connector of the electronic devices. Sometimes, the plug connectors of electronic devices are too large, and the charging power strip is too small to support the plug connectors of electronic devices, which makes it difficult to stably insert the plug connectors into the charging power strip.

### BRIEF DESCRIPTION OF DRAWINGS

Embodiments of the present disclosure will now be described, by way of embodiment, with reference to the attached figures.

FIG. 1 is a three-dimensional structural diagram of a separable power strip of an embodiment of the present disclosure.

FIG. 2 is an exploded schematic diagram of the separable power strip shown in FIG. 1.

FIG. 3 is a three-dimensional structural diagram of a main body of the separable power strip shown in FIG. 1.

FIG. 4 is a three-dimensional structural diagram of the main body of the separable power strip from another angle shown in FIG. 3.

FIG. 5 is a three-dimensional structural diagram of a separable member of the separable power strip shown in FIG. 1.

FIG. 6 is a schematic three-dimensional structural view of the separable member of the separable power strip from another angle shown in FIG. 5.

FIG. 7 is an enlarged schematic view of a VII portion of the main body of the separable power strip shown in FIG. 4.

FIG. 8 is a side view of the separable power strip shown in FIG. 1.

FIG. 9 is a sectional view of the separable power strip shown in FIG. 8 along line A-A′, a first fixed assembly and a second fixed assembly of the main body and a part of a circuit board of the separable member are omitted.

FIG. 10 is a sectional view of the separable power strip shown in FIG. 1 along line B-B′.

FIG. 11 is an exploded schematic diagram of the main body shown in FIG. 2.

FIG. 12 is an exploded schematic diagram of the separable member shown in FIG. 2.

FIG. 13 is an exploded schematic diagram of the separable member from another angle shown in FIG. 12.

FIG. 14 is a state diagram when inserting the conducting pin of the separable member into a second socket interface of the main body.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

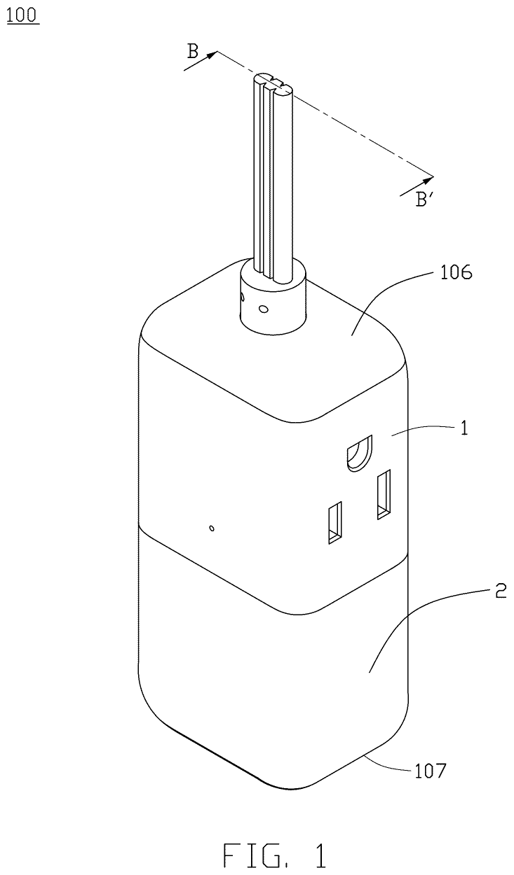

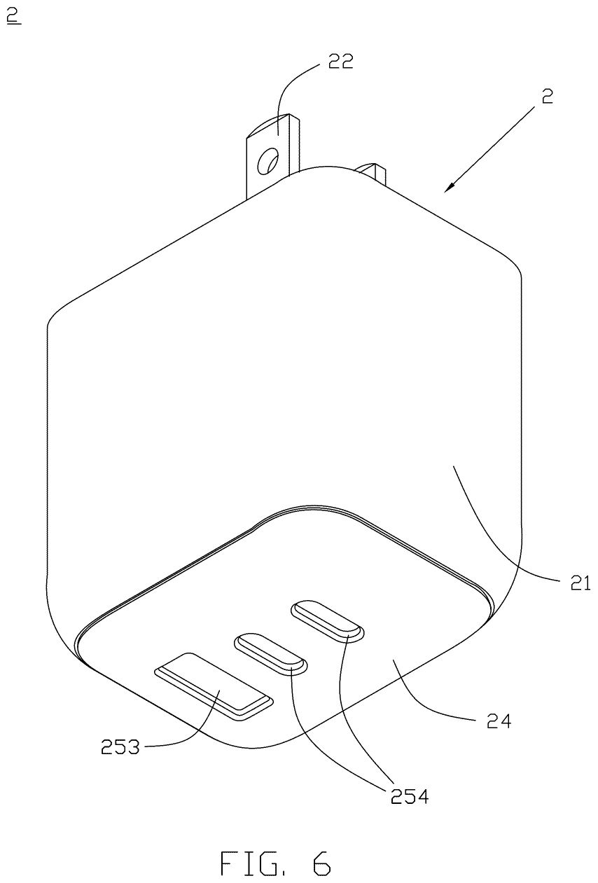

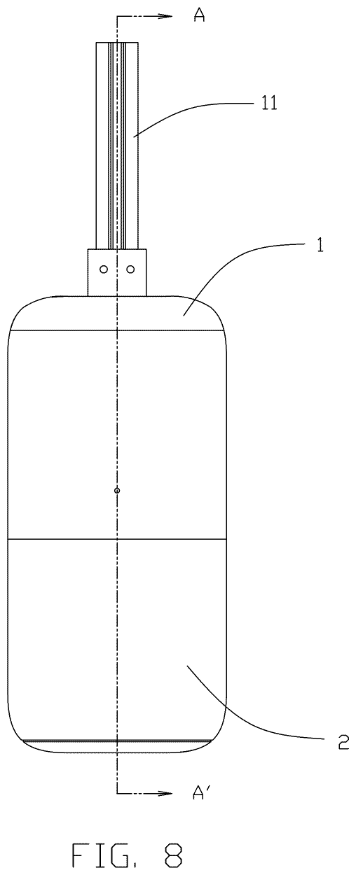

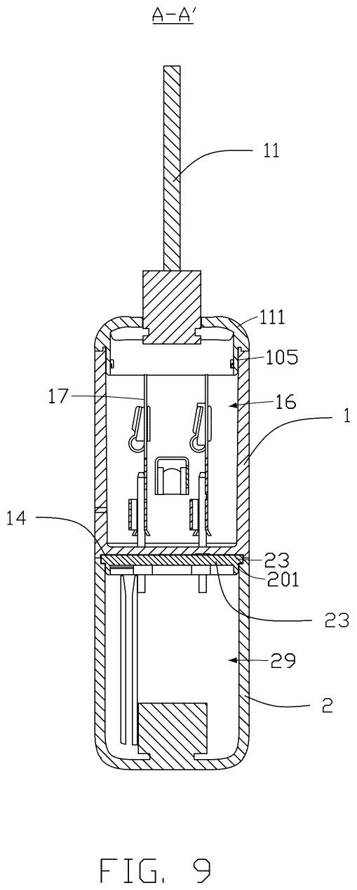

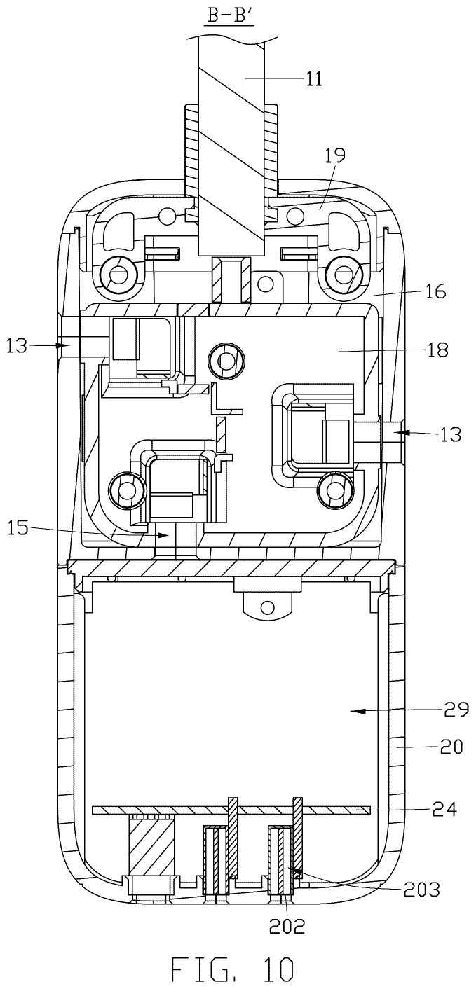

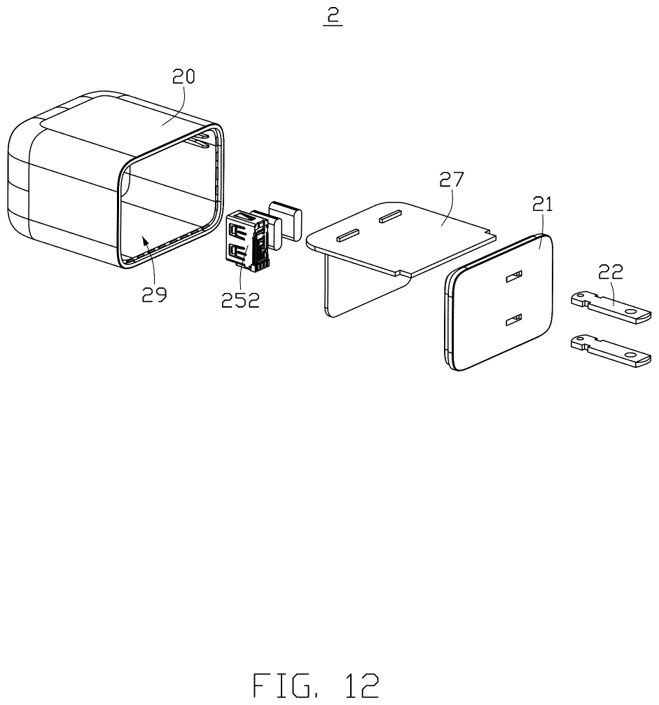

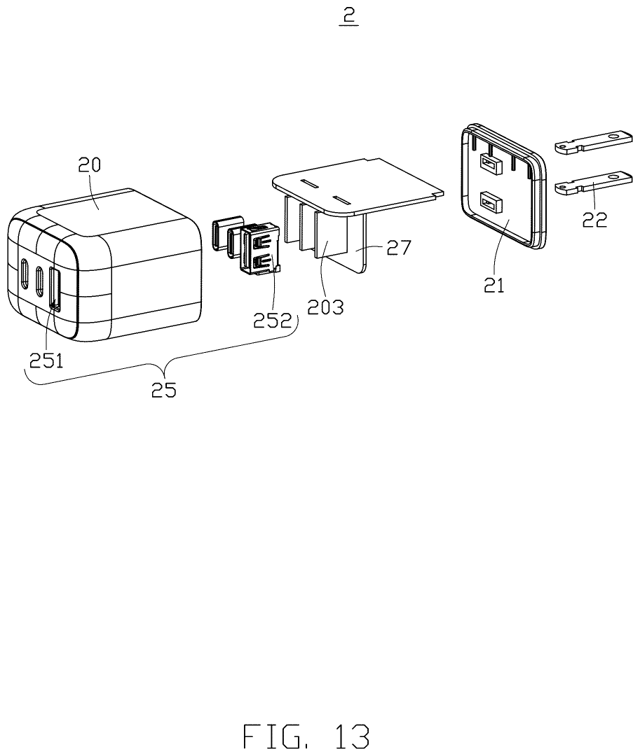

Referring to FIGS. 1 to 14, the present disclosure provides a separable power strip 100 connected to a power (not shown) via a power line 11 and configured to supply power to an electronic device (not shown), the electronic device may be a mobile phone, a tablet computer, a mobile hard disk, a mobile power supply, or a notebook computer.

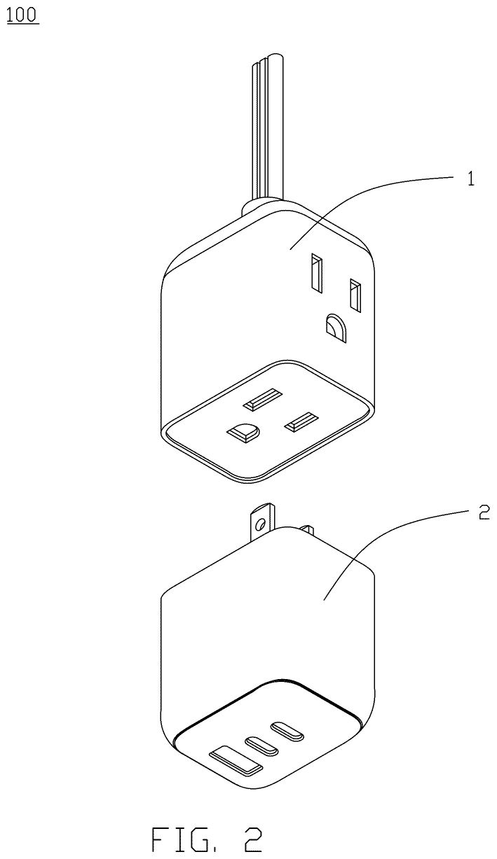

Referring to FIG. 1 and FIG. 2, in this embodiment, the separable power strip 100 includes a first end 106 and a second end 107 opposite to the first end 106. the separable power strip 100 includes a main body 1 located in a side of the separable power strip 100 adjacent to the first end 106 and a separable member 2 located in the second end 107 and separably and electrically coupled the main body 1, so that the main body 1 and the separable member 2 of the separable power strip 100 can be used separately or as a whole to form a columnar body, so as to be able to change the size of the charging power strip according to the size of the plug of the electronic devices and charge different electronic devices. The separable member 2 is electrically connected with the main body 1 by inserting a conducting pin 22 of the separable member 2 into a socket interface (a first socket interface 15 or a third socket interface 13 described later) of the main body 1.

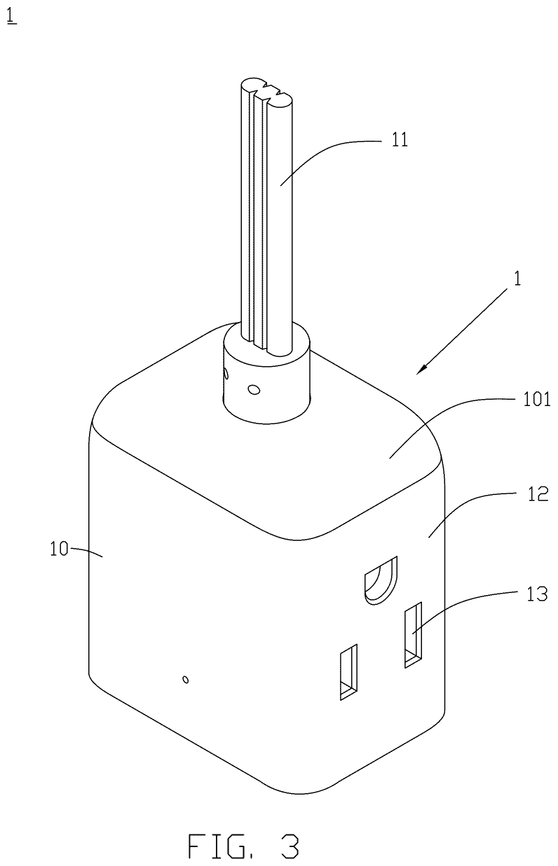

Referring to FIG. 3 to FIG. 6 and FIG. 10 to FIG. 11, a specific structure of the separable power strip 100 in the present disclosure is described in detail.

The main body 1 of the separable power strip 100 in the present disclosure can be connected to the power line 11, the power line 11 may be a single line or a row line in which three lines are connected in parallel, which is not limited herein. The main body 1 includes a first housing 10, a first socket interface 15, a third socket interface 13, a first electrical outlet assembly 17, a first fixed assembly 18, and a second fixed assembly 19. The first housing 10 has a frame-shaped structure with a first opening 105 defined on one side thereon.

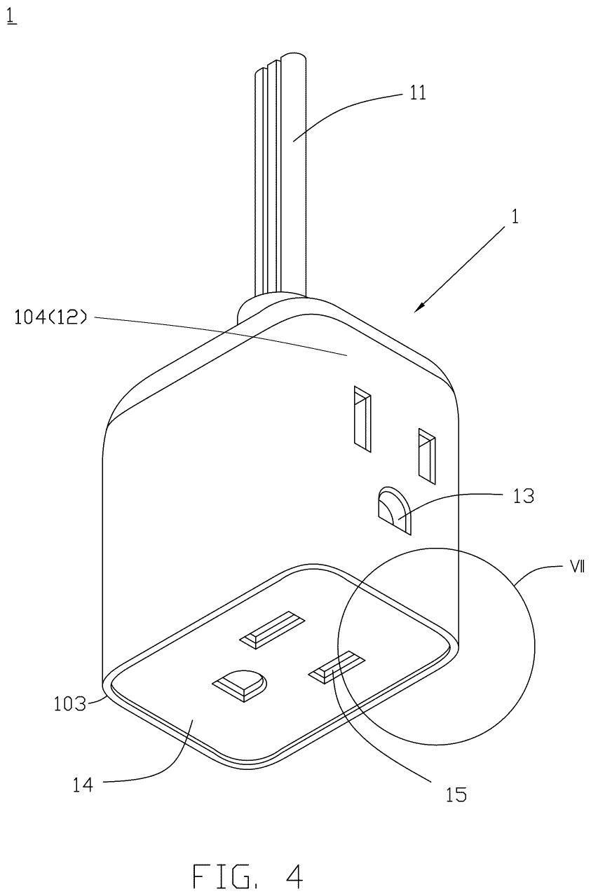

Referring to FIG. 4 and FIG. 9 to FIG. 11, the first housing 10 includes a top wall 101, a first contacting wall 103 and a first peripheral side wall 104 surrounding the first contacting wall 103 and including a plurality of first side walls 12, the first contacting wall 103 and the first peripheral side wall 104 defining a first receiving cavity 16 (for example, a sub-receiving cavity) with the first opening 105. The top wall 101 is fixedly disposed at the side with the first opening 105 of the first housing 10 and opposite the first contacting wall 103.

The top wall 101 includes a through hole 111 configured for one end of the power line 11 to pass through, so that the power line 11 can be electrically connected to the first electrical outlet assembly 17, thereby supplying power to the electronic device through the main body 1. When the separable member 2 is connected with the main body 1, the top wall 101 is located at the first end 106 of the separable power strip 100.

The first contacting wall 103 defines a concave portion 14 configured for receiving a protrusion 23 of the separable member 2, which will be described later. In addition, the first socket interface 15 is defined on a bottom wall 141 of the concave portion 14.

In addition, the first peripheral side wall 104 includes a plurality of first side walls 12, at least one first side wall 12 is provided with one third socket interface 13 configured for connecting a conducting pin of the electronic device or the conducting pin 22 of the separable member 2.

Further, the first socket interface 15 includes a plurality of first insertion holes 151 defined on the first contacting wall 103 and a plurality of first connectors 153. The positions where the first connector 153 are disposed correspond with the positions on the first contacting wall 103 where the first insertion holes 151 are disposed. The first connectors 153 may contact the conducting pin 22 of the separable member 2 or a conducting pin of the electrical device plugged in the first socket interface 15.

The first socket interface 15 may be either one or a combination of three-slot or two-slot interface.

The third socket interface 13 includes a plurality of second insertion holes 131 defined on the first peripheral side wall 104 and a plurality of second connectors 133. The positions where the second connectors 133 are disposed correspond with the positions on the first side walls 12 where the second insertion holes 131 are disposed. The second connector 133 may contact the conducting pin 22 of the separable member 2 or the conducting pin of the electrical device plugged in the third socket interface 13.

The third socket interface 13 may be either one or a combination of three-slot or two-slot socket interface.

The third socket interface 13 may be the same as or different from the first socket interface 15, which is not limited herein.

In this embodiment, both the first socket interface 15 and the third socket interface 13 are three-slot socket interface.

In addition, in this embodiment, the first housing 10 is substantially rectangular, and includes four first side walls 12. In this embodiment, two of the four first side walls 12 are provided with the third socket interface 13. In other embodiments, one, three, or four first side walls 12 can be provided with the third socket interface 13, which is not limited herein.

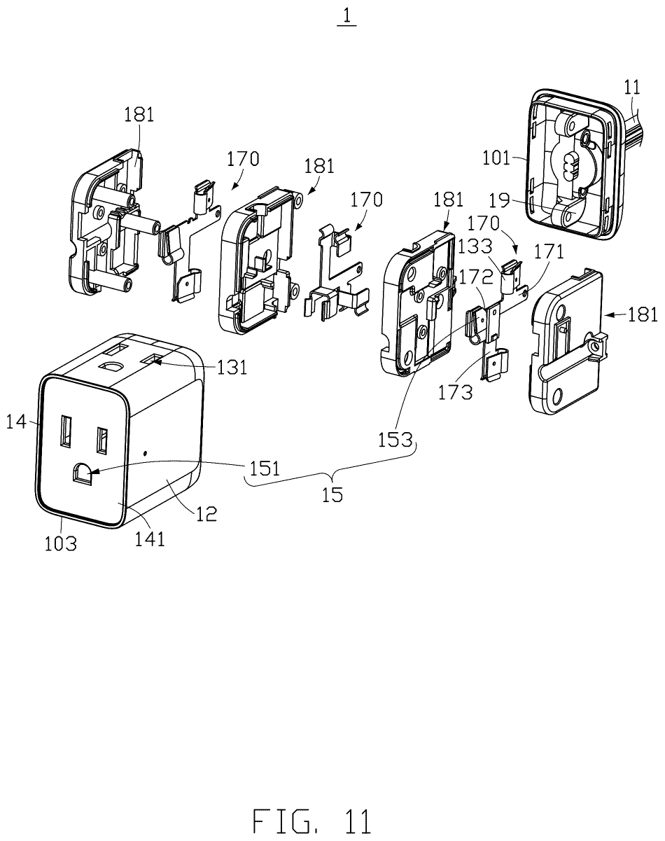

Further, referring to FIG. 11, the first electrical outlet assembly 17 includes a plurality of conductive terminals 170 configured for connecting the power line 11 and the first socket interface 15 and the third socket interface 13, thereby allowing the electronic devices to connect to the first socket interface 15 or the third socket interface 13 for receiving the electrical power.

Each of the conductive terminals 170 includes a first connecting member 171, a second connecting member 172, and at least one third connecting member 173. An end of the first connecting member 171 is electrically connected to the power line 11. An end, away from the first connecting member 171, of the second connecting member 172, is provided with the first connector 1721 of the first socket interface 15.

An end of the at least one third connecting member 173 is provided with the second connector 133 of the third socket interface 13.

The first connecting member 171 and the second connecting member 172 are arranged oppositely and located at two ends of the conductive terminal 17, the at least one third connecting member 173 is disposed substantially perpendicular to a connecting line between the first connecting member 171 and the second connecting member 172.

In this embodiment, each of the conductive terminals 170 includes two third connecting members 173 extended from the connecting line between the first connecting member 171 and the second connecting member 172 in two opposite directions, and the extension directions thereof are substantially perpendicular to the connecting line between the first connecting member 171 and the second connecting member 172. The arrangement and structure of the first connecting member 171, the second connecting member 172, and the two third connecting members 173 can be adjusted according to requirements, which are not limited herein.

The first fixed assembly 18 is configured for fixing the first electrical outlet assembly 17 inside the first receiving cavity 16. In this embodiment, the first fixed assembly 18 includes four fixed members 181 arranged in sequence, and each of the conductive terminals 170 is arranged between adjacent fixed members 181. The first connector 153 and the second connector 133 are exposed to the first fixed assembly 18. The structures of the four fixed members 181 are adjusted according to the corresponding structure of the conductive terminals 170, which is not limited here.

The second fixed assembly 19 is configured for fixing the power line 11 to the top wall 101 and is arranged on one side of the first fixed assembly 18.

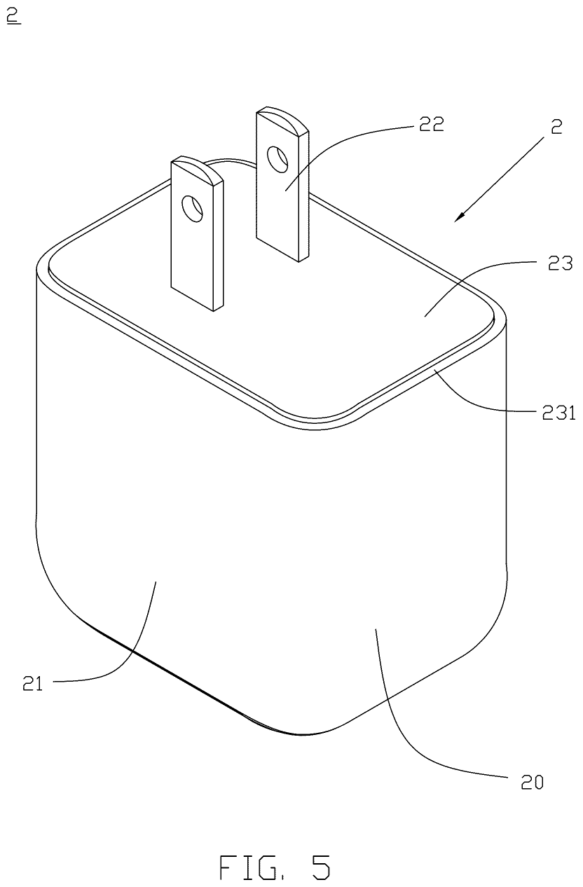

Referring to FIG. 5 to FIG. 6 and FIG. 12 to FIG. 13, the separable member 2 of the separable power strip 100 includes a second housing 20, an insertion wall 24, the conducting pin 22, a circuit board 27, a second socket interface 25, and a second electrical outlet assembly 203.

The second housing 20 and the first housing 10 form a body housing of the separable power strip 100. The second housing 20 includes a second contacting wall 21 having a same shape with the first contacting wall 27 and a second peripheral side wall 201 surrounding the second contacting wall 21. The second housing 20 has a frame-shaped structure with a second opening 201 defined on one side, and the second contacting wall 27 is disposed at one side with the second opening 201 of the second housing 20.

The second contacting wall 27 is provided with the conducting pin 22 electrically coupled to the second socket interface 25 and configured for selectively inserting the main body 15 or the separable member 13, so that the main body 1 and the separable member 2 are separably and electrically connected. The first socket interface 15 may be an example of a male socket, the conducting pin 22 may be an example of a female socket, which is capable of electrically connecting to the male socket through an insertion engagement.

Further, the second contacting wall 27 includes a protrusion 23 protruding outward from the end of the second peripheral side wall 201, and the conducting pin 22 is arranged on the protrusion 23. When the conducting pin 22 is inserted into the first socket interface 15, the protrusion 23 is received in the concave portion 14 and contacts the bottom wall 141 of the concave portion 14. In this embodiment, the second contacting wall 27 is protruding from the edges of the second side walls 28 and forms the protrusion 23, so that a step structure is formed between the protrusion 23 and the edges of the second side walls 28, that is, an abutting surface 231 is formed on the periphery of the edges of the second side walls 28. When the separable member 2 and the main body 1 are connected together, the protrusion 23 is received in the concave portion 14 and contacts the bottom surface of the concave portion 14, and at the same time, the abutting surface 231 abuts against the side wall of the concave portion 14, so that the separable member 2 and the main body 1 are tightly connected together.

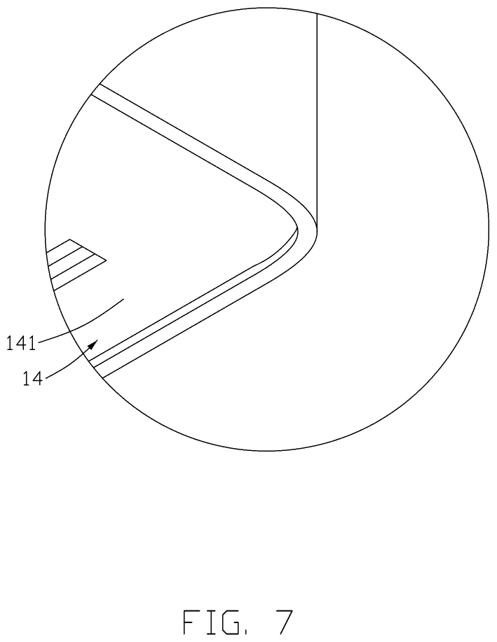

Referring to FIG. 7 to FIG. 9, the shape and size of the protrusion 23 of the separable member 2 match the concave portion 14 of the main body 1, so that the protrusion 23 and the concave portion 14 can be mated with each other.

The second peripheral side wall 201 surrounds the insertion wall 24, the insertion wall 24 and the second peripheral side wall 201 defining a second receiving cavity 29 (for example, a sub-receiving cavity) with the second opening 201 on one side, the second receiving cavity 29 is configured for receiving the circuit board 27 and the second electrical outlet assembly 203. In other words, the second receiving cavity 29 and the first receiving cavity 16 form a receiving cavity formed by the body housing, a separatable interlayer member located between the first end 106 and the second end 107 divides the receiving cavity into two sub-receiving cavities (for example, the second receiving cavity 29 and the first receiving cavity 16). The separatable interlayer member includes the first contacting wall 103, the second contacting wall 21, the male socket and the female socket.

The second socket interface 25 has a different interface type with the first socket interface 15 and the third socket interface 13 and configured for receiving a USB plug therein and supplying electrical power to the portable electronic device connected with the second socket interface 25. The second socket interface 25 includes at least one third insertion hole 251 defined on the insertion wall 24 and at least one third connector 252. The position where the at least one third connector 252 is disposed correspond with the position on the insertion wall 24 where the at least one third insertion hole 251 are disposed.

The second socket interface 25 comprises at least one of a USB-A interface, a Type-C interface, a Lightning interface, and a Micro-USB interface. In this embodiment, the second socket interface 25 includes a USB interface 253 or two Type-C interfaces 254.

The conducting pin 22 and the second socket interface 25 are located on different side walls of the separable member 2, and the conducting pin 22 is selectively coupled to the first socket interface 15 or the third socket interface 13.

The second electrical outlet assembly 203 is received in the second receiving cavity and is corresponding to the second socket interface 25, and electrically connected to the circuit board 27.

The USB interface 251 and the Type-C interface 252 are configured for connecting to a USB connector or a Type-C connector of a data cable of electronic devices such as smart phones, laptops, or mobile hard disks to achieve the transmission of current and data signals.

Since the separable power strip 100 of the present disclosure includes the first socket interface 15 and the third socket interface 13, and the USB interface 253 or the Type-C interface 252, it can be used as a power converter, a USB conversion plug, or an independent socket.

Referring to FIG. 1 again, when the conducting pin 22 of the separable member 2 is inserted into the first socket interface 15, that is, the main body 1 and the separable member 2 of the charging plug are used as a whole, the main body 1 and the separable member 2 of the separable power strip 100 are tightly connected to and snap-fitted with each other, the first contacting wall 13 directly contacts the second contacting wall 23, and an outer edge of the first contacting wall 13 is aligned with an outer edge of the second contacting wall 23, a portion of the first peripheral wall and a portion of the second peripheral wall in a same side forms a continuous planar surface, and the second socket interface 25 is electrically connected to the power via the conducting pin 22 of the separable member 2, the first socket interface 15, and the first electrical outlet assembly 17. The continuous planar surface is configured for supporting larger plug connectors of electronic devices.

When the separable member 2 separates from the main body 1, that is the second contacting wall 21 separates from the first contacting wall 103, at least one of the main body 1 and the separable member 2 is configured for being a sole electrical socket or sub-power socket, that is an independent socket. At this time, the main body 1 can support smaller plug connectors of electronic devices. in addition, users can insert the conducting pin 22 of the separable member 2 into a power plug, and then insert charging cables of the electronic device into the USB interface 253 or the Type-C interface 252 of the separable member 2, so as to charge the electronic device.

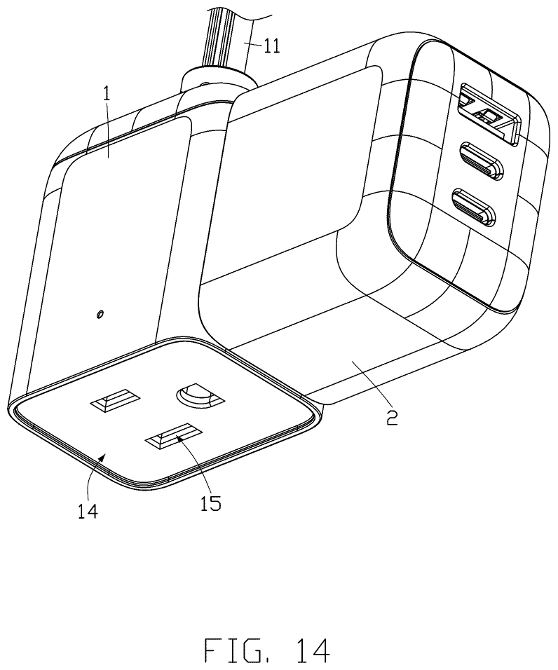

In other embodiment, referring to FIG. 14, when the conducting pin 22 of the separable member 2 is inserted into the third socket interface 13, the first contacting wall 103 is arranged corresponding to one of the second side walls 28, a portion of the first contacting wall 103 and a portion of the corresponding one second side wall 28 form the continuous planar surface. In this way, the conducting pin 22 of the separable member 2 can be selectively inserted into the first socket interface 15 or the third socket interface 13 according to different requirements.

Compared with the prior art, the separable power strip 100 of the present disclosure includes a main body 1 configured for connecting to a power supply and a separable member 2 with the conducting pin 22 that can be used separately and independently. In this way, users can choose whether to connect the separable member 2 to the main body 1 based on the size of the plug connector of the electronic device. The main body 1 and the separable member 2 can be separately connected to a power supply socket, etc., so as to charge the electronic device such as a mobile phone or a tablet computer, and are combined into a whole to be used as a power supply converter or a USB conversion plug. In addition, the separable power strip 100 of the present disclosure has the advantages of small volume, light weight, and convenience in carrying while ensuring the diversity of charging functions.

What is claimed is:

1. A separable power strip, comprising:
a main body connected to a power via a power line and comprising:
a first housing comprising a first contacting wall and a first peripheral side wall surrounding the first contacting wall, the first contacting wall and the first peripheral side wall defining a first receiving cavity;
a first socket interface located in the first contacting wall; and
a first electrical outlet assembly connected to the first socket interface and the power line, and received in the receiving cavity; and
a separable member separably and electrically coupled to the main body and comprising:
a second housing comprising a second contacting wall having a same shape with the first contacting wall and a second peripheral side wall surrounding the second contacting wall;
a second socket interface having a different interface type with the first socket interface; and
a conducting pin electrically coupled to the second socket interface and located in the second contacting wall; and
wherein when the conducting pin of the separable member is inserted into the first socket interface of the main body, the first contacting wall directly contacts the second contacting wall, and an outer edge of the first contacting wall is aligned with an outer edge of the second contacting wall, a portion of the first peripheral wall and a portion of the second peripheral wall in a same side forms a continuous planar surface, and the second socket interface is electrically connected to the power via the conducting pin of the separable member, the first socket interface, and the first electrical outlet assembly; and
when the separable member separates from the main body, at least one of the main body and the separable member is configured for being a sole electrical socket.

2. The separable power strip according to claim 1, wherein a concave portion is defined on the first contacting wall, and the first socket interface is defined on a bottom wall of the concave portion,
a protrusion is arranged on the second contacting wall, the conducting pin is arranged on the protrusion, and when the conducting pin is inserted into the first socket interface, the protrusion is received in the concave portion.

3. The separable power strip according to claim 1, wherein the main body further comprises at least one third socket interface connected to the first electrical outlet assembly,
the first peripheral side wall comprises a polarity of first side walls, each of the at least one third socket interface is arranged on one of the polarity of first side walls.

4. The separable power strip according to claim 3, wherein the at least one third socket interface is arranged on the portion of the first peripheral wall.

5. The separable power strip according to claim 3, wherein the first socket interface or the at least one third socket interface is either one or a combination of three-slot or two-slot interface.

6. The separable power strip according to claim 3, wherein the first electrical outlet assembly comprises a plurality of conductive terminals, each of the plurality of conductive terminals comprises a first connecting member, a second connecting member, and at least one third connecting member, an end of the first connecting member is electrically connected to the power line, an end, away from the first connecting member, of the second connecting member is coupled to the first socket interface, and an end of the at least one third connecting member is coupled to the corresponding one of the at least one third socket interface.

7. The separable power strip according to claim 6, wherein the first socket interface comprises a plurality of first insertion holes defined on the first contacting wall and a plurality of first connectors arranged on the end, away from the first connecting member, of the second connecting member,
the third socket interface comprises a plurality of second insertion holes defined on the first peripheral side wall and a plurality of second connectors arranged on the end of the at least one third connecting member.

8. The separable power strip according to claim 6, wherein the main body further comprises a first fixed assembly configured for fixing the plurality of conductive terminals inside the first receiving cavity.

9. The separable power strip according to claim 8, wherein the first fixed assembly includes four fixed members arranged in sequence, and each of the conductive terminals is arranged between adjacent fixed members.

10. The separable power strip according to claim 9, wherein the main body further comprises a second fixed assembly configured for fixing the power line to the first housing and arranged on one side of the first fixed assembly.

11. The separable power strip according to claim 1, wherein the separable member further comprises a circuit board received in the second receiving cavity, the circuit board is electrically connected to the second socket interface and the conducting pin, respectively.

12. The separable power strip according to claim 1, wherein the second socket interface comprises at least one of a USB-A interface, a Type-C interface, a Lightning interface, and a Micro-USB interface.

13. The separable power strip according to claim 1, wherein the conducting pin is a three-conducting pin or a two-conducting pin.

14. A separable power strip configured for inserting into a power supply, comprising:
a columnar body comprising:
a body housing comprising:
a first end connected to the power supply via a power line;
a first socket interface located in a side of the body housing adjacent to the first end;
a second end opposite to the first end; and
a second socket interface located in the second end;
a first electrical outlet assembly connected to the first socket interface and accommodated into a receiving cavity formed by the body housing; and
a second electrical outlet assembly connected to the second socket interface and accommodated into the receiving cavity; and
wherein the body housing further comprises a separatable interlayer member located between the first end and the second end, and configured for dividing the receiving cavity into two sub-receiving cavities, and
wherein the separable interlayer member comprises:
a first contacting wall adjacent to the first end,
a second contacting wall facing to the first contacting wall and closer to the second end than the first contacting wall,
a male socket located in the first contacting wall, and
a female socket located in the second contacting wall and being capable of electrically connecting to the male socket through an insertion engagement; and
the second contacting wall is capable of separating from the first contacting wall, so as to divide the column body into two sub-power sockets, each of which is an independent socket.
